(19) United States
(12) Patent Application Publication
(10) Pub. No.: US 2009/0248491 A1
(43) Pub. Date: Oct. 1, 2009

(54) System and method for ranking participating venues in a network according to advertisers needs for targeted advertising

(76) Inventor: Mark Hemphill, Charlottetown (CA)

Correspondence Address: FLYNN THIEL BOUTELL & TANIS, P.C., 2026 RAMBLING ROAD, KALAMAZOO, MI, 49008-1631, US

(21) Appl. No.: 12/229,944

(22) Filed: Aug. 28, 2008

(30) Foreign Application Priority Data
Mar. 27, 2008 (CA) 2 622 824

(51) Int. Cl. G06F 17/30

(52) U.S. Cl. 705/10

(57) ABSTRACT

The present invention relates to an improved advertising network and system, which relates to interconnecting a plurality of venues through a network, each venue having at least one display panel or display screen for displaying advertisements and marketing materials to a plurality of people at these venues. The venues in the network are ranked in terms of their potential communicative power, according to a defined list of advertising effectiveness criteria, this ranking being reflected as a V-Index, so as to properly assess the potential marketing effectiveness of advertising displayed at each of the venues. Advertisers or users can also provide advertising preferences information (such as demographics preferences) in accessing the network, so as to locate a listing of pertinent venues, and display screens at these venues, where the particular demographic sought is found to be most prevalent. In this manner, advertisers or users can identify, pinpoint and direct a targeted advertising display towards a specific subset of display screens or display panels at selected venues in the network with a view to catering their advertising displays to a specific clientele at these selected venues, based on the advertising preferences information and the ranking each of the venues in the network.

### FIELD OF THE INVENTION

The present invention relates generally to an advertising system and network for interconnecting a plurality of venues through a network, and more particularly to an advertising system and network which pairs buyers and sellers of advertising space, whereby an advertiser can identify, pinpoint and direct an advertising display towards a specific subset of display screens at selected ones of the plurality of venues in the network with a view to catering to a specific clientele in the selected venues. Further, the present invention relates to an advertising system and network whereby each of the venues in the network can be ranked in terms of their potential communicative power.

### DESCRIPTION OF THE PRIOR ART

Owners and operators of public facilities which double as public gathering places, which will also be referred to herein as “venues”, are increasingly recognizing the opportunities inherent in their position as a provider of strategic marketing messages, these messages being delivered to the public by means of display screens or display panels at these public facilities. Such establishments and institutions generally entertain a captive audience, and these can include, for example, restaurants and bars, car dealerships, conventional retail establishments, heath and fitness centers, office buildings, elevators, lobbies, lounges, vestibules, waiting rooms, corner stores, campuses and even street corners, if one considers the marketing potential of display screens present at Times Square in New York. In addition, display screens or display panels are increasingly becoming mobile, such as those used in the context of trade shows, sales displays, or even outdoor events.

As the cost of computers and screen technology continues to decrease, display screens and panels are becoming more and more commonplace, and available to be viewed by the public, in a multitude and wide ranging variety of locations, as noted above. Furthermore, as the connectivity and accessibility of even small establishments and businesses having these display screens or panels to wide ranging global networks (such as, for example, the Internet) continues to increase, the potential exists to provide an improved interconnected advertising network which can enable such establishments and businesses to create and manage intelligent custom screen displays for their clients or customers, and which pairs buyers and sellers of advertising space. In so doing, this can provide an opportunity for owners and operators of such establishments and businesses to add value to their existing business, by generating new revenue as sellers of advertising spaces. While presently, advertising networks do exist which allow for owners and operators of establishments and businesses to sell advertising space to generate revenue, opportunities are limited for advertisers to focus and concentrate their marketing efforts and advertising displays to a specific subset of display screens or panels at selected venues over an interconnected and linked communications network with a view to targeting their marketing and advertising efforts towards, and catering to, a specific clientele. For example, an advertiser may wish to focus and direct their marketing efforts over an interconnected network to a specific type of clientele, such as an audience of over-50 fitness oriented people in a specific geographic location, with a view to having display screens or panels at these locations advertise displays and marketing material catering to this targeted clientele.

Accordingly, there is a need for an improved advertising method and system which is able to interconnect a plurality of public gathering places (or “venues”), and which pairs buyers and sellers of advertising space, whereby an advertiser can identify, pinpoint and direct advertising displays and marketing materials towards a specific subset of display screens for showing at selected ones of the plurality of venues over an interconnected and linked c network with a view to catering to a specific clientele right at the point-of-sale in the selected venues. Moreover, there is a need for an improved advertising method and system which allows for venues in the network to be individually ranked in terms of their potential communicative power to an audience, with a view to maximizing marketing effectiveness. To this end, the present invention effectively addresses these needs.

### SUMMARY OF THE INVENTION

A general object of the present invention is to provide an improved advertising network and system for interconnecting a plurality of venues through an interconnected and linked network, and which effectively pairs together buyers and sellers of advertising space to establish a shared resource and a marketplace for exchanging content and ad space.

A further object and advantage of the present invention is to provide an improved advertising network and system which allows for venues in the network to be ranked in terms of their potential communicative power, with a view to maximizing marketing effectiveness.

A still further object and advantage of the present invention is to provide an improved advertising network and system, whereby an advertiser can identify, pinpoint and direct an advertising display towards a specific subset of display screens or display panels at selected ones of the plurality of venues in the network with a view to catering to a specific clientele in the selected venues.

According to one aspect of the present invention, there is provided a system for providing targeted advertising in a network, the system comprising interconnecting a plurality of venues through the network, each of the venues having means for displaying one or more advertisements to a plurality of people; providing means for receiving advertising preferences information from a user; providing means for ranking each of the plurality of venues in the network according to a defined list of advertising effectiveness criteria; providing means for the user to target a specified segment of the plurality of people from selected venues in the network to receive an advertising display, based on the advertising preferences information and the ranking each of the plurality of venues in the network; and displaying the advertising display to the specified segment of the plurality of people at the selected venues in the network.

According to another aspect of the present invention, there is provided a method for providing targeted advertising in a network, the system comprising interconnecting a plurality of venues through the network, each of the venues having means for displaying one or more advertisements to a plurality of people; providing means for receiving advertising preferences information from a user; providing means for ranking each of the venues in the network according to a defined list of advertising effectiveness criteria; providing means for the user to target a specified segment of the plurality of people from selected venues in the network to receive an advertising display, based on the advertising preferences information and the ranking each of the venues in the network; creating the advertising display based on the advertising preferences information that is targeted to the specified segment of the plurality of people in the network; and displaying the advertising display to the specified segment of the plurality of people at the selected venues in the network.

According to a still further aspect of the present invention, there is provided a method for providing targeted advertising in a network, the system comprising interconnecting a plurality of venues through the network, each of the venues having means for displaying one or more advertisements to a plurality of people; providing means for receiving advertising preferences information from a user; providing means for ranking each of the venues in the network according to a defined list of a plurality of individual attributes for each of the plurality of venues; providing means for the advertiser to target a specified segment of the plurality of people from selected venues in the network to receive an advertising display, based on the advertising preferences information and the ranking of each of the venues in the network; creating the advertising display based on the advertising preferences information that is targeted to the specified segment of the plurality of users in the network; and displaying the advertising display to the specified segment of the plurality of people at the selected venues in the network, wherein the step of providing means for ranking each of the venues further comprises (a) providing a numerical scale for each of the individual attributes on the defined list; (b) providing the scale with a plurality of numerical rankings that are each associated with a rating indicative of a level to which each of the venues achieves each of the individual attributes; (c) assessing the level to which each of the venues achieves each of the individual attributes and awarding each of the venues a corresponding rating for each of the individual attributes; (d) totaling the ratings related to each of the individual attributes to provide a total score for each of the venues; (e) dividing, for each of the venues, the total score by a number of each of the individual attributes to obtain an average score; (f) totaling the ratings related to each of the individual attributes to provide a total score for all of the venues to obtain a mean average score; (g) subtracting the mean average score from the average score, and thereafter dividing an outcome of this subtraction by the standard deviation to obtain a Z score for each of the venues; and (h) dividing, for each of the venues, the obtained Z score by one tenth, and adding this amount to a constant pre-set value to obtain a V-index score.

In essence, the advertising network and system of the present invention is a venue-oriented network, which is fundamentally based on the loose coupling of venues being able to power their own public information displays and ad content and can, at their sole discretion, establish relationships with marketers either on a one-to-one basis, or en masse by joining a program or using a value-added service. Such public information displays can include, but are not limited to, a selection of original custom-created content, one or more subscriptions to third party content (including advertisements), and additional data-driven functionality like news feeds, online video playlists, and so forth. Marketers, also, can take up accounts and establish relationships with venues on a one-to-one basis, or en masse, to create, or port, content on the system and, through these relationships, establish technical connections with each venue in order to have this content distributed to any local public information display screen or panel.

In this manner, the present invention provides an improved advertising network and system through which advertisers and marketers can identify and access local, nuanced display screens and screenscapes both directly through point-to-point relationships and en masse through value-added programs and services.

### BRIEF DESCRIPTION OF THE DRAWINGS

A preferred embodiment of the present invention is described below with reference to the accompanying drawings, in which:

FIG. 1 illustrates a flowchart, in accordance with an embodiment of the present invention;

FIG. 2 is a diagram of one possible Internet embodiment of a hardware configuration for which the present invention could be applied; and

FIG. 3 is a diagram illustrating a possible searching component consistent with an aspect of the present invention.

### DESCRIPTION OF THE PREFERRED EMBODIMENT

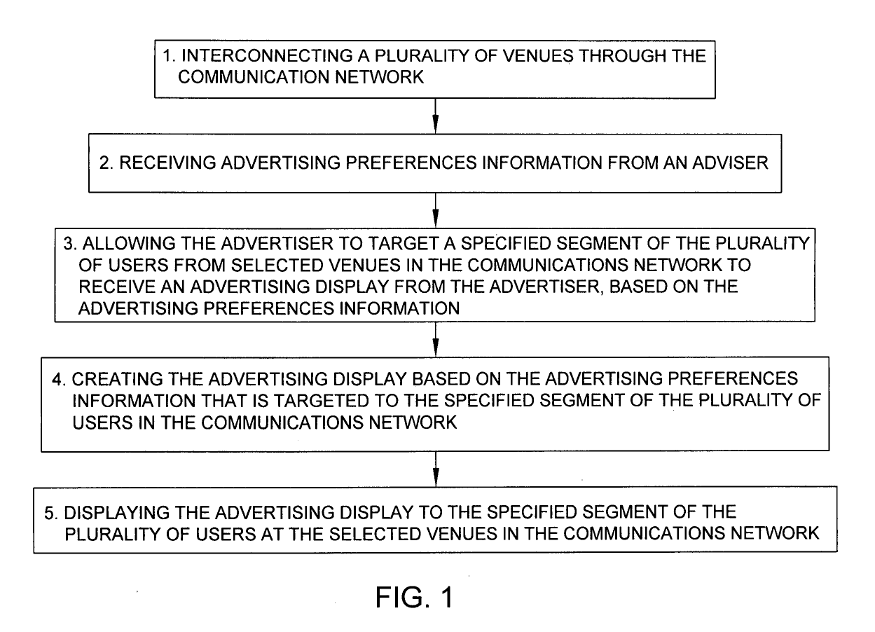

In a preferred embodiment, the present invention essentially provides an improved advertising system and method which is able to interconnect a plurality of public gathering places or facilities (“venues”), and which pairs buyers and sellers of advertising space, whereby an advertiser can identify, pinpoint and direct an advertising display towards a specific subset of display screens or display panels at selected ones of the plurality of venues in the network pinpoint with a view to catering to a specific clientele right at the point-of-sale in the selected venues, and thus focusing their marketing efforts thereto. FIG. 1 is a flow chart illustrating operation of the advertising system and method consistent with one aspect of the present invention.

It will of course be understood that any facility that doubles as a public gathering place could be considered a venue in the context of the present invention, as would be clear to one skilled in the art. It will also be understood that a display screen or display panel, as used in the context of the present invention, refers to a public information display that is meant for the purposes of communicating to the public at that venue. This can include, but is not limited to, flat screen displays, televisions, computer monitors or monitors, or the like.

The present invention is designed to interconnect a plurality of venues through an interlinked network, as a network based community. This is preferably done through the venues subscribing to become members of that network based community, but is not absolutely essential. This provides a viral network and collective of venues interconnecting to establish a shared resource and a marketplace for exchanging content and ad space amongst its membership. It will, of course, be understood that as more venues participate in the network the value of the network builds exponentially, with each member thus helping to make the service more attractive to marketers, and more potentially lucrative as an installed base of potential customers. In essence, the more members of the network means a greater number of people that are potentially accessible for exposure to display screens and display panels in each of the venues of the advertising network.

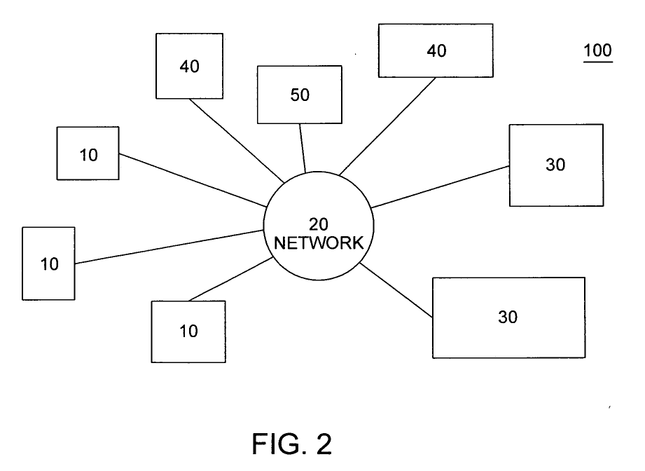

FIG. 2 is a block diagram of an example of the advertising system 100 through which the present invention may be implemented, though it will be understood that variations to this, in terms of setup and arrangement, are possible. Generally speaking, system 100 includes a number of public gathering places or facilities (“venues”) 10 that are members of a network based community, and which are linked to one another by means of a network 20, it being understood that the venues 10 are connected to one or more servers 50 via the network 20. It will also be understood that the term, “network” as used in the context of the present invention, can refer to a wired network, the Internet, a wireless network, a cellular telephone network, a telecommunications network or a mobile network, for use in conjunction with devices designed to operate on these platforms, such as wireless devices, televisions, monitors, mobile/telephone devices, or any other apparatuses or platform configurations, as would be apparent to one skilled in the art. It is also conceivable that the present invention could be utilized in conjunction with a television environment, and that the network may include a local area network (LAN), a wide area network (WAN), a telephone network, such as the Public Switched Telephone Network (PSTN), an intranet, the Internet, or a combination of networks.

In the context of the present invention, it is also conceivable that the “network” could comprise and link together a plurality of venues in a specific geographic location, such as, for example, Boston, as a local network, and that this local network could be interconnected and linked to one or more other local networks in other geographic locations. Thus, an extensively linked national and globally linked advertising network, in an alternative embodiment of the present invention, is possible, the linking of such networks to one other being accomplished through conventional means, as would be apparent to one skilled in the art. In such manner, targeted advertising displays can be displayed to a specified segment (or demographic) of people at selected venues in the primary network and other interconnected and linked networks.

In a preferred embodiment, one or more network administrators 30 will also be connected and have access to the network 20. In this manner, the one or more network administrators 30 will be able to receive targeted advertising displays and marketing material from advertisers (or create such targeted advertising displays) for broadcast over the network 20 to specific display panels and screens (not shown) at selected venues 10, depending, as noted previously, on the advertising preferences of the advertiser, with a view to directing and concentrating their advertising efforts to a specific clientele in the selected venues, as will hereinafter be described.

It is also conceivable that advertisers 40 can have access to the network 20, as shown in FIG. 2, whereby advertisers can create targeted advertising displays and marketing materials for broadcast over the network 20 to specific display panels and screens (not shown) at selected venues 10, it being understood that advertisers 40 are entities that wish to broadcast advertisements, advertising displays or marketing materials to one or more venues 10 on the network 20. However, in a preferred embodiment, advertisers will create or conceive of the targeted advertising displays or marketing materials, and this will be provided to network administrators 30, who will then effect broadcast of the advertising display or marketing materials over the network 20.

In an alternative embodiment, venue managers at each of the venues 10 can receive the targeted advertising displays or marketing materials from advertisers (or create, edit and maintain these materials themselves) and the venue managers will then effect broadcast of the advertising display or marketing materials over the network 20, whether to the venue at which the venue manager is located, or to numerous selected venues in the network 20.

In accordance with a preferred embodiment of the present invention, the present invention provides for an improved advertising network and system that allows for each of the plurality of venues in the communications network to be ranked in terms of their potential communicative power, with a view to maximizing marketing effectiveness. In a preferred embodiment, every venue in the communications network is assigned a “V-index”, which is indicative of and reflects the potential marketing effectiveness of each venue, in terms of the power of their display screen installations. Some examples of metrics that can be utilized in assessing a venue's V-index can include, but are not limited to, the average daily audience size at that venue and the number of display panels or screens at the venue. Obviously, the greater the audience size, and the greater the number of display panels and screens at a particular venue, is generally more desirable, since this provides a greater potential audience through which a targeted advertising display can be seen.

These examples of metrics can be seen with reference to the Table 1 given below.

TABLE 1
Screen Power

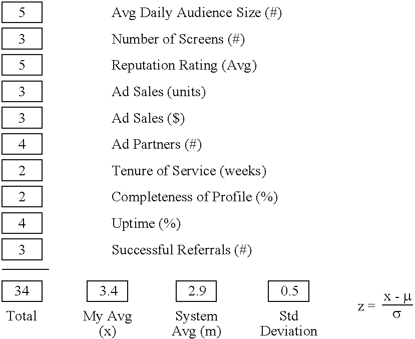

Legend (largely percentile based)
1 = −10p 2 = −10p-30p 3 = −30p-50p 4 = −50p-+70p 5 = +70p
1 = −10p 2 = −10p-30p 3 = −30p-50p 4 = −50p-+70p 5 = +70p
1 = 1 star 2 = 2 star 3 = 3 star 4 = 4 star 5 = 5 star
1 = −10p 2 = −10p-30p 3 = −30p-50p 4 = −50p-+70p 5 = +70p
1 = −10p 2 = −10p-30p 3 = −30p-50p 4 = −50p-+70p 5 = +70p
1 = −10p 2 = −10p-30p 3 = −30p-50p 4 = −50p-+70p 5 = +70p
1 = −10p 2 = −10p-30p 3 = −30p-50p 4 = −50p-+70p 5 = +70p
1 = −10p 2 = −10p-30p 3 = −30p-50p 4 = −50p-+70p 5 = +70p
1 = −10p 2 = −10p-30p 3 = −30p-50p 4 = −50p-+70p 5 = +70p
1 = −10p 2 = −10p-30p 3 = −30p-50p 4 = −50p-+70p 5 = +70p

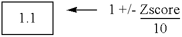

Again with reference to Table 1, other examples of metrics that can be utilized in assessing a venue's V-index can include, but are not limited to, the reputation rating of the venue; a number of advertising sales for each of the venues; length of tenure of service of that venue on the network; the particular geographic location of each of the venues; hours of operation of each of the venues; days of operation of each of the venues; the number of advertisers connected to each of the venues; and, in an alternative embodiment of the present invention, consideration can also be given for venues that have referred other venues or establishments to subscribe to become a member of the network. It will, of course, be understood that variations to these metrics are possible, as would be readily apparent to one skilled in the art.

It should be noted that a V-index is tabulated by taking the average score of a list of ratings for individual attributes of a venue that offers evidence of a powerful network-based public information display. For example, in the example shown in Table 1, there can be seen a number of metrics each having a numerical scale (shown as “Legend” in the Table), and a plurality of numerical rankings that are each associated therewith to denote a rating indicative of a level or degree to which each of the venues ranks in achieving each of these individual metrics attributes. The level to which each of the venues achieves each of the individual metrics attributes is assessed and each of the venues is awarded a corresponding rating for each of the individual metrics attributes. These ratings are then totaled to provide a total score for each of the venues. This total score (shown as “34” in Table 1) is then divided by the number of each of categories of individual metrics attributes (10 listed in Table 1) that are present to obtain an average score for a venue. In the example shown in Table 1, the average score of one venue can be seen as being (3.4)

The average score of the selected venue is then compared with the average score (ie: the mean) of all venues when measured across the same attributes, which is shown in Table 1 as being (2.9). The mean average score is then subtracted from the average score, and, thereafter, the outcome of this subtraction is divided by the standard deviation from the mean (0.5) to obtain a Z score for each of the venue. This equation can be noted in Table 1 as being:

$$z = \frac{x - μ}{σ}$$

Finally, for each of the venues, the obtained Z score is then divided by one tenth, and this amount is added to a constant pre-set value (shown in Table 1 as being “1”) to obtain a V-index score. In essence, a V-index is equal to 1 (a constant) plus the quotient of that z-score divided by 10.

It should be noted that the degree of variation from the mean (shown as being 0.5) is measured using standard Z-scores. Thus, in the example shown in Table 1, the V-index of one particular venue is calculated as 1.1, as shown below:

$$\begin{matrix}Z = \frac{3.4 - 2.9}{0.5} = 1 \\ V index = 1 + 1 / 10 = 1.1\end{matrix}$$

The constant 1 provides a convenient proxy for an average venue. As an example, in the present invention a 1.0 V-index represents a venue with a public information display that is considered average in its quantitative communicative power, and a 0.9 V-index represents a venue with a public information display that is considered below average—1 standard deviation below the mean. A V-index of 1.1 represents a venue with a public information display that is above average—1 standard deviation above the mean, and so forth. Thus, in the present invention, V-indexes may range from 0.6 to 1.4 and follow a normal distribution, though variations to this will be understood to be possible.

In the example shown in FIG. 2, three venues 10, two network administrators 30, two advertisers 40 and one server 50 have been illustrated as being connected to network 20 for simplicity, though, in practice, there may be more or fewer venues 10, network administrators 30, advertisers 40 and servers 50 connected to network 20.

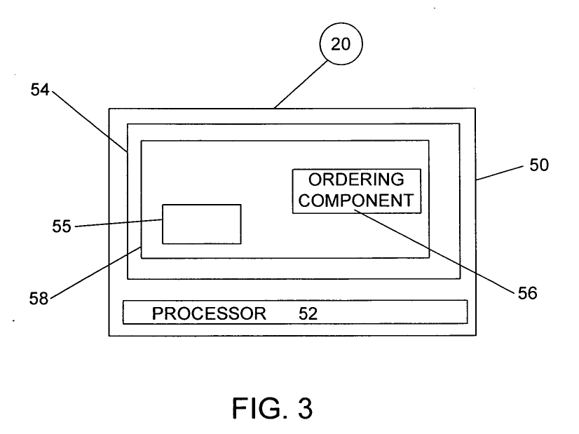

Similar to the client devices noted above, and as noted in FIG. 3, server 50 may include a processor 52 coupled to a computer-readable memory 54, it being understood that server 50 may additionally include a secondary storage element, such as a database (not shown), as would be apparent to one skilled in the art. In essence then, the server 50 performs the function of a network-based database, storing the inner logic of the system, such as accounts (memberships), content portfolios or presentations, and relationships, including subscriptions, which define the sharing of advertising content within the system. Such a database may also have saved thereon, for example, pertinent information regarding each of the venues 10 on the network 20. This information may include, but is not limited to, demographic information from each venue concerning primary and secondary audiences, age group of such audience, lifestyle, ratio of male to female, secondary audiences, location of venue, locations of display panels and screens at each of the venues, and the like. Client processors (not shown) and server processor 52 can be any of a number of well known computer processors.

It will be understood that server 50, although depicted as a single computer system in FIGS. 2 and 3, may be implemented as a network of computer processors, as would be apparent to one skilled in the art.

### In Operation

In utilizing the advertising system and network of the present invention, an advertiser, through either their own contact to network 20, or through contact via a network administrator 30 or venue manager (as noted previously) will access the network 20 through one or more servers 50 connected thereto. In accessing the network, one skilled in the art would appreciate that an automated software tool (that runs in a standard web browser) and creates a custom branded screen display (providing an orientation, layout, skin, and colour scheme) could be utilized, to create and play, for example, a multi-part presentation consisting of various text and image-based elements, including video, according to a presentation prepared by a venue manager (or advertiser). Thus, for example, five display screens or panels in one establishment or venue may be powered by the same presentation prepared by a venue manager or advertiser.

Server 50 may operate as, for example, a network server and include search engine 58. In one implementation, search engine 58 may function as a query-based search engine, to locate relevant information in response to search queries. In response to client requests, search engine 58 may return information to users (hereinafter referred to as “clients”) of the network 20, whether they be advertisers 40, administrators 30 or venues 10, by returning a list of relevant information to the client, which relate to relate to information regarding venues connected to network 20.

The client requests being provided through search engine 58 would comprise advertising preferences information criteria, whereby an advertiser can identify, pinpoint and direct an advertising display towards a specific subset of display screens or display panels at selected venues (or screens at these locations) in the communications network with a view to catering to a specific clientele right at the point-of-sale in the selected venues, thus focusing their marketing efforts thereto. The advertising preferences information criteria entered into the search engine, as noted previously, could comprise, but is not limited to, demographic information from each venue concerning primary and secondary audiences, age group of such audience, lifestyle, ratio of male to female, secondary audiences, location of venue, locations of display panels and screens at each of the venues, and the like.

For example purposes only, an advertiser may wish to tailor an advertising display or marketing materials to venues having a high proportion of a male 18-24 age group, and being predominantly sports oriented. The information may be returned to clients as a listing of venues where this particular demographic is found to be most prevalent. This list of links may be ranked and displayed in an order based on the search engine's determination of relevance to the search query.

Search engine 58 includes a venue criteria locator 55 and an ordering component 56. In general, venue criteria locator 55 locates information whose contents match a user search query. Ordering component 56 may rank the located information based on relevance and may generate a relevance score for each document that indicates a level of relevance. Ordering component 56 assists search engine 58 in returning relevant information to the user by placing in order and ranking the set information identified by venue criteria locator 55. This ranking may take the form of assigning a numerical value, such as a pertinency score, corresponding to the calculated relevance of each piece of demographic criteria identified by venue criteria locator 55. There are a number of suitable ranking algorithms known in the art, and, as such, will not be described further herein. In a similar manner, these suitable prior art ranking algorithms can be used to rank each of the venues in the communications network in assessing each venue's “V-Index” and once this has been accomplished, to provide a listing to the user of a ranked order of each of the venues, from highest to lowest, or in other variations.

Once the pertinent venues on the network 20 have been located by the advertiser, a targeted advertising display can be created and directed to these specific venues having the desired demographic sought by the advertiser. Then, broadcasting of this tailored advertising display to these venues can be coordinated and effected through conventional means, as known to persons skilled in the art, it being understood that such an advertising display could comprise a plurality of advertisement, a slide slow of various advertisements, or the like. As noted previously, the advertising network of the present invention can be utilized by an advertiser or marketer to identify, pinpoint and direct a specific targeted advertising display towards a specific subset of display screens or panels at selected venues in the network with a view to catering to a specific clientele in these venues, if so desired.

It will also be readily understood by one skilled in the art that an interactive software tool, accessed through a browser, could be utilized by venue managers (or advertisers or marketers) in creating and configuring their own script (aka: program or playlist) for programming a custom branded public information display presentation consisting of their choice of various text and image-based elements. As noted prevously, such a presentation could include a selection of original custom-created content, one or more subscriptions to third party content including advertisements, and additional data-driven functionality like news feeds, or online video playlists or the like.

It will also be understood that such a tailored advertising display could be prepared by advertisers and marketers and then forwarded, by conventional means, to one or more network administrators for broadcast at the selected venues in the network. Alternatively, the tailored advertising display could also be created by one or more network administrators for broadcast at the selected venues in the network, based upon advertising preferences information criteria and the ranking of each of the venues in the network according to the defined list of advertising effectiveness criteria.

It will be understood that entities accessing the network 20 will be utilizing client devices (not shown), which may include a wireless telephone, a personal computer, a personal digital assistant (PDA), a lap top, or another type of computation or communication device, a thread or process running on one of these devices, and/or an object executable by one of these devices. Such client devices will each include a computer-readable medium, such as random access memory, coupled to a processor, for executing program instructions stored in memory, as would be readily apparent to one skilled in the art. Client devices may also include a number of additional external or internal devices, such as, without limitation, a mouse, a CD-ROM, a keyboard, and a display. In general, client devices may be any type of computing platform connected to a network and that interacts with application programs, such as a digital assistant or a “smart” cellular telephone or the like. Of course, through such client devices, entities can communicate over network 20, and with other systems and devices coupled to network 20.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the present invention is not limiting of the present invention. Thus, the operation and behavior of the aspects were described without reference to the specific software code, it being understood that a person of ordinary skill in the art would be able to design software and control hardware to implement the aspects based on the description herein.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A system for providing targeted advertising in a network, the system comprising:
interconnecting a plurality of venues through the network, each of the venues having means for displaying one or more advertisements to a plurality of people;
providing means for receiving advertising preferences information from a user;
providing means for ranking each of the plurality of venues in the network according to a defined list of advertising effectiveness criteria;
providing means for the user to target a specified segment of the plurality of users from selected venues in the network to receive an advertising display, based on the advertising preferences information and the ranking each of the plurality of venues in the network; and
displaying the advertising display to the specified segment of the plurality of people at the selected venues in the network.

2. The system of claim 1, wherein the network is the Internet.

3. The system of claim 1, wherein the network is a wired network, a wireless network, a cellular telephone network, a telecommunications network, an interconnected network or a mobile network.

4. The system of claim 1, wherein the network is a local area network (LAN), a wide area network (WAN), a telephone network, such as the Public Switched Telephone Network (PSTN), an intranet, the Internet, or a combination of interconnected and linked networks.

5. The system of claim 1, wherein the means for displaying the one or more advertisements to the plurality of people is at least one image display screen located at each of the venues.

6. The system of claim 1, wherein the at least one screen is a computer monitor, a monitor, a display panel, a mobile telephone, cellular device, or television.

7. The system of claim 1, wherein the advertising display comprises a plurality of advertisements.

8. The system of claim 4, wherein the network can be interconnected and linked to at least one additional interconnected and linked network.

9. The system of claim 1, wherein each of the plurality of venues subscribe to become members of the network.

10. The system of claim 5, wherein the advertising effectiveness criteria comprises an average daily audience size at each of the venues, a number of display screens at each of the venues, a reputation rating of the venue, a number of advertising sales for each of the venues, length of tenure of service in the network, a geographic location of each of the venues, hours of operation of each of the venues and days of operation of each of the venues.

11. The system of claim 1, wherein the ranking of each of the plurality of venues in the network is provided to the user as a ranking order.

12. The system of claim 1, wherein the ranking order is implemented by a programmed computer.

13. The system of claim 1, wherein the advertising display is forwarded to one or more network administrators for broadcast at the selected venues in the network

14. The system of claim 1, wherein the advertising display is created by one or more network administrators for broadcast at the selected venues in the network.

15. The system of claim 8, wherein the advertising display is displayed to the specified segment of the plurality of people at selected venues in the network and the at least one additional interconnected and linked network.

16. A method for providing targeted advertising in a network, the system comprising:
interconnecting a plurality of venues through the network, each of the venues having means for displaying one or more advertisements to a plurality of people;
providing means for receiving advertising preferences information from a user;
providing means for ranking each of the venues in the network according to a defined list of a plurality of individual attributes for each of the plurality of venues;
providing means for the advertiser to target a specified segment of the plurality of people from selected venues in the network to receive an advertising display, based on the advertising preferences information and the ranking of each of the venues in the network;
creating the advertising display based on the advertising preferences information that is targeted to the specified segment of the plurality of users in the network; and
displaying the advertising display to the specified segment of the plurality of people at the selected venues in the network.

17. The method of claim 16, wherein, after the step of creating the advertising display, the advertising display is forwarded to one or more network administrators for broadcast at the selected venues in the network.

18. The method of claim 16, wherein the step of providing means for ranking each of the venues further comprises:
(a) providing a numerical scale for each of the individual attributes on the defined list;
(b) providing the scale with a plurality of numerical rankings that are each associated with a rating indicative of a level to which each of the venues achieves each of the individual attributes;
(c) assessing the level to which each of the venues achieves each of the individual attributes and awarding each of the venues a corresponding rating for each of the individual attributes;
(d) totaling the ratings related to each of the individual attributes to provide a total score for each of the venues;
(e) dividing, for each of the venues, the total score by a number of each of the individual attributes to obtain an average score;
(f) totaling the ratings related to each of the individual attributes to provide a total score for all of the venues to obtain a mean average score;
(g) subtracting the mean average score from the average score, and thereafter dividing an outcome of this subtraction by the standard deviation to obtain a Z score for each of the venues;
(h) dividing, for each of the venues, the obtained Z score by one tenth, and adding this amount to a constant pre-set value to obtain a V-index score.

19. The method of claim 18, wherein the constant pre-set value is 1.

20. The method of claim 18, wherein the obtained V-index scores for all of the venues are positioned for viewing in a ranked order from highest to lowest.
